(19) United States
(12) Patent Application Publication
(10) Pub. No.: US 2026/0257806 A1
(43) Pub. Date: Sep. 3, 2026

(54) VERTICAL TAKE-OFF AND LANDING AIRCRAFT

(71) Applicant: Mihail Hristov Peychev, Sofia (BG)

(72) Inventor: Mihail Hristov Peychev, Sofia (BG)

(21) Appl. No.: 18/873,178

(22) PCT Filed: Apr. 21, 2023
(86) PCT No.: PCT/BG2023/000012

§ 371 Date: Dec. 9, 2024

(30) Foreign Application Priority Data
Jul. 5, 2022 (BG) 113556

(51) Int. Cl. B64D 35/06; B64C 27/20; B64C 27/48; B64C 27/56; B64C 27/59; B64C 27/78; B64C 27/82; B64D 29/00; B64D 33/02; B64D 33/04; B64D 33/10

(52) U.S. Cl. CPC B64D 35/06; B64C 27/20; B64C 27/48; B64C 27/56; B64C 27/59; B64C 27/78; B64C 27/82; B64D 29/00; B64D 33/02; B64D 33/04; B64D 33/10; B64C 2027/8227

(57) ABSTRACT

The inventions will find application in aviation, particularly for passenger and cargo transport, in emergency medical care, etc. The aircraft comprises a frame 2 with casing 3 and at least one engine 4 mounted to the frame 2, and at least four thrusters 5, 6—two front thrusters 5 and two rear thrusters 6 respectively, connected to the engine 4 by a transmission. The transmission is mechanical, but other transmission types are suitable for each particular project. The mechanical transmission includes a transfer case 8 connected to the internal combustion engine 4 via a clutch 34. The transfer case 8 is coupled via a front cardan shaft 35 and a rear cardan shaft 36 to, a front reduction gear 13 and a rear reduction gear 14 which are coupled via flexible gears 12 to the fans 9 of the thrusters. Suitably, each reduction gear is connected to a pair of fans 9. The engine 4 is an internal combustion engine and is selected from the group of reciprocating engines, rotary engines, gas turbine engines and the like. The thrusters are provided to propel and move the aircraft.

### TECHNICAL FIELD

The vertical take-off and landing aircraft will find application in aviation, particularly for passenger and cargo transport, in emergency medical care, etc.

### BACKGROUND ART

Aircrafts are known that have electric propulsion, significantly limiting flight duration and resulting in poor dynamic performance, due primarily to the large mass of the batteries and the electric motors, whose weight is close to the thrust generated. Such vehicles are typically unable to fly more than 5-10 metres above the ground and have a range of no more than 15 minutes with significantly unacceptable dynamic performance and payload capacity. Most of the known aircrafts have wings or propellers (in the case of helicopters), which increase their overall dimensions considerably and require the presence of a runway or take-off pad.

US2010294877A1 describes an aircraft comprising a frame with a two-section casing that has a plurality of openings compactly incorporated to conduct airflow. Double panels are disposed in the front, connected laterally to the body. At the rear of the aircraft, twin V-shaped blades are fitted with hollow spaces for airflow passage. At the top of the aircraft, a plurality of pairs of cylindrical rotating nozzles are located laterally. The aircraft incorporates automotive transport equipment, including wheels, on which it treads and permits transitions for movement between ground and air environments. The aircraft may be used as a vehicle on urban roads with a minimum width of not less than 2 m. Direct control of the fuel by the pilot is provided, which does not allow its precise dosing. There are several gearboxes, which leads to a significantly large mass and a corresponding reduction in payload and degradation of aircraft dynamics. The provided rotating nozzles also contribute to the degradation of the dynamic properties of the vehicle, as well as to losses from linear and local resistances. There is a high level of sound pressure. The said thrust generation due to the specific shape of the fuselage is only possible with the apparatus already moving.

### DISCLOSURE OF INVENTION

The problem to be solved by the invention is to provide fast and safe transport of passengers and cargo.

The problem is solved by a vertical take-off and landing aircraft (VTOL) comprising a frame with casing and at least one engine mounted to the frame. The engine is of the internal combustion engine type and is connected by a transmission to at least four fans of at least four thrusters. Each thruster includes an inlet air duct having a narrowed portion in which the fan with blades having a variable angle of attack is disposed. Each fan has a transmission shaft bearing in a straightening device (stator) located below the fan and rigidly mounted to the frame. There is an outlet air duct below the straightening device. An inlet fairing is mounted on top of each fan and an outlet support fairing is mounted to the straightening device. Guide flaps are mounted in at least two of the outlet air ducts.

According to an embodiment, any two adjacent fans have opposite directions of rotation.

The internal combustion engine is selected from the group of reciprocating, rotary, gas turbine engines.

It is envisaged, as an embodiment, that the transmission comprises a transfer case connected to the internal combustion engine via a clutch. The transfer case is connected via a front cardan shaft and a rear cardan shaft to front and rear reduction gears which are connected via flexible gears to the fans.

Suitably, the flexible gears should be of the belt or chain type.

According to an embodiment, each reduction gear is connected to a pair of fans.

Cooling systems are provided for the internal combustion engine and for the reduction gears and the transfer case.

Suitably, the cooling systems should have radiator boxes with inlet grilles formed in the casing and connected to corresponding cooling ducts formed between the inlet grilles and the outlet air ducts of the respective thrusters.

In one embodiment, the straightening device (stator) has stationary radial blades mounted to a hub to which a control mechanism for varying angle of attack of the fan blades is also mounted.

In one embodiment of the invention, the hub of the straightening device is a truss structure to which the stationary radial blades are mounted via their inner end.

Advantageously, the hub is enclosed by thin-walled panels.

In one embodiment, the hub of the straightening device may be made as a casting.

According to an embodiment, the stationary radial blades of the straightening device have an outer end with mounting parts mounted to the frame, to which outer end outer enclosing thin-walled panels are fixed.

Advantages of the vertical take-off and landing aircraft according to the invention are that it can carry passengers, no special platform for take-off and landing being necessary. It is more stable and easier to control due to better dynamic characteristics than those of the known aircrafts. The aircraft described here can fly at significantly higher altitudes than the known aircrafts and can achieve vertical accelerations of up to 4 m/s² in horizontal position from rest on the ground or in the air, loaded with two passengers of 75 kg each and a full tank of fuel under normal physical conditions, and can reach altitudes of 2500-3000 m. Another great advantage of the aircraft is that the amount of fuel in a full tank is enough for a flight of 45 minutes to 1 hour at a constant full load of the thrusters and the engine with two people on board. Precise dosing of air and fuel entering the engine is organized in order to achieve high engine brake power while maintaining low engine toxicity and good economical parameters. Only one transfer case is provided, obtaining the lightest possible transmission from the engine to the fans. The specific layout of the thrusters, and in particular the layout of their inlet air ducts, allows the generation of additional lifting force while the apparatus is stationary. Known elements for which the principles of construction are familiar, are used in the design of the aircraft arranged and connected in a new way which is technologically easy to manufacture and leads to unexpected results based on the know-how in the field to date. The overall frame provided allows a reduction in the total mass of the apparatus.

### BRIEF DESCRIPTION OF DRAWINGS

FIG. 1—General view of the vertical take-off and landing aircraft according to the invention;

FIG. 2—General view, according to the invention, of the vertical take-off and landing aircraft with casing partially removed;

FIG. 3—Top view of the vertical take-off and landing aircraft according to the invention;

FIG. 4—Side view of the vertical take-off and landing aircraft, showing the engine and transmission;

FIG. 5—Detail top view of the thrusters at the rear of the aircraft with casing removed;

FIG. 6—View of a fan with straightening device of an aircraft thruster;

FIG. 7—Rear view of the vertical take-off and landing aircraft with casing partially removed.

### EXAMPLES OF THE INVENTION EMBODIMENTS

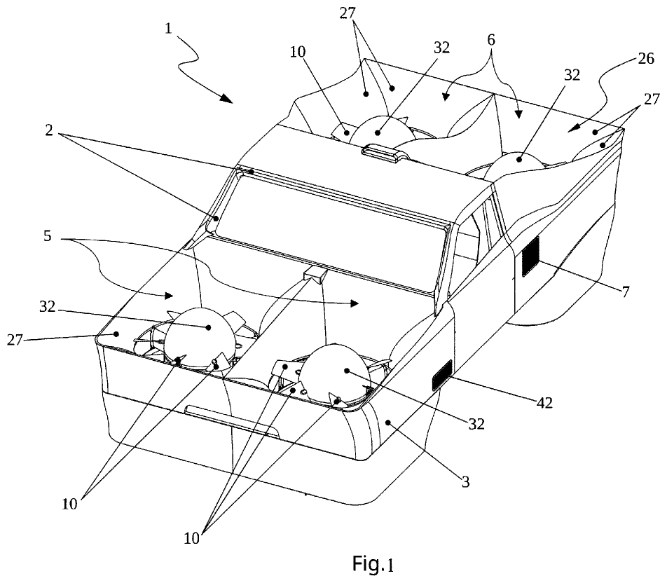

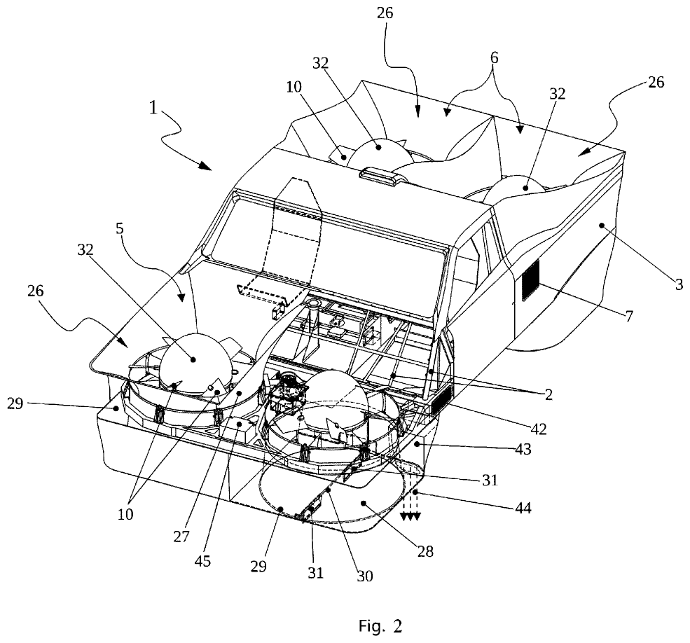

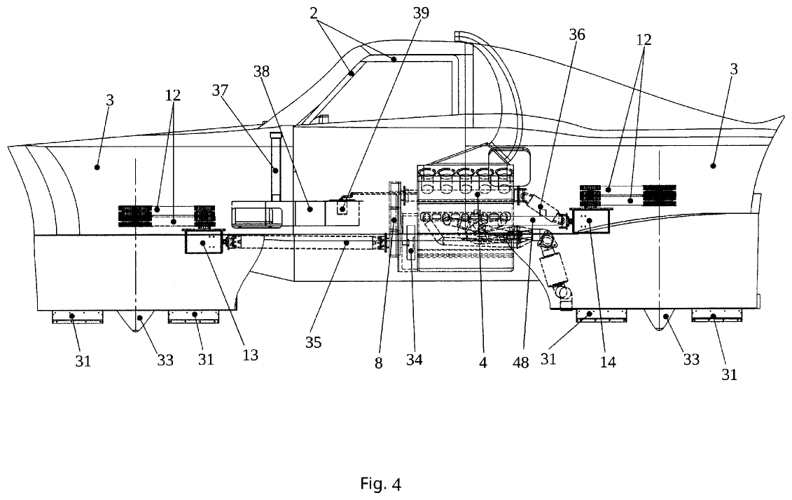

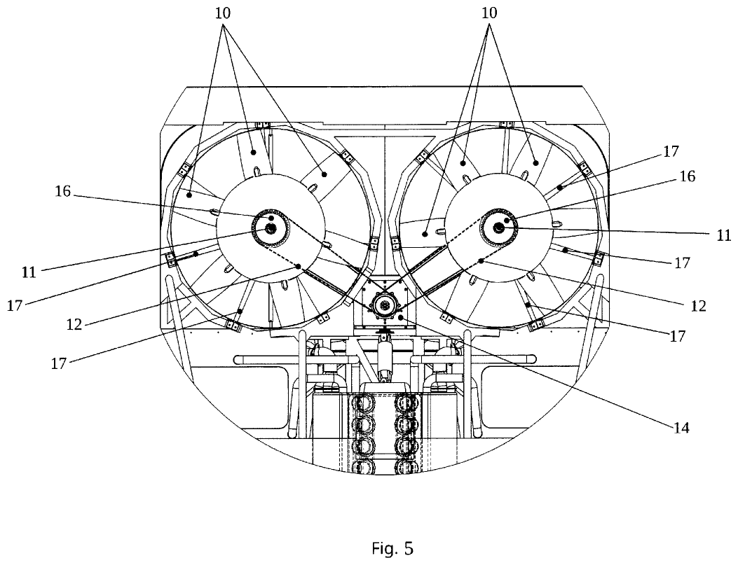

According to the invention, the vertical take-off and landing aircraft 1 is shown in more detail in FIGS. 1 and 2. It comprises a frame 2 with casing 3 and at least one engine 4 (FIG. 4) mounted to the frame 2, and at least four thrusters 5, 6—two front thrusters 5 and two rear thrusters 6 respectively, connected to the engine 4 by a transmission. In the illustrated example, the transmission is mechanical, which does not exclude other transmission types suitable for each particular project. The mechanical transmission best shown in FIG. 4 includes a transfer case 8 connected to the internal combustion engine 4 via a clutch 34. The transfer case 8 is coupled via a front cardan shaft 35 and a rear cardan shaft 36 to, a front reduction gear 13 and a rear reduction gear 14 which are coupled via flexible gears 12 to the fans 9 of the thrusters 5, 6. Suitably, each reduction gear 13, 14 is connected to a pair of fans 9 as shown in FIG. 5. The engine 4 is an internal combustion engine and is selected from the group of reciprocating engines, rotary engines, gas turbine engines and the like. At least four thrusters 5, 6 are provided to propel and move the vertical take-off and landing aircraft 1. The transfer case 8 shown in FIG. 4 is provided for distributing the mechanical power between the front thrusters 5 and the rear thrusters 6.

The internal combustion engine 4 has a radiator 48 disposed in a radiator box with an inlet grille 7 formed in the casing 3.

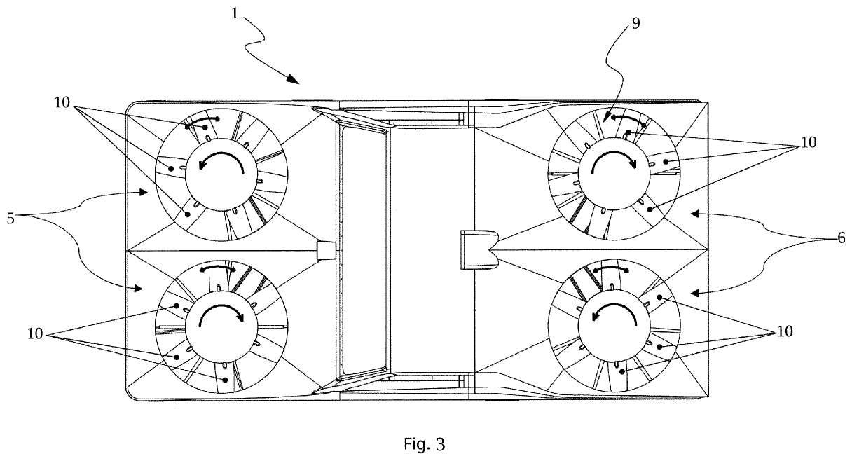

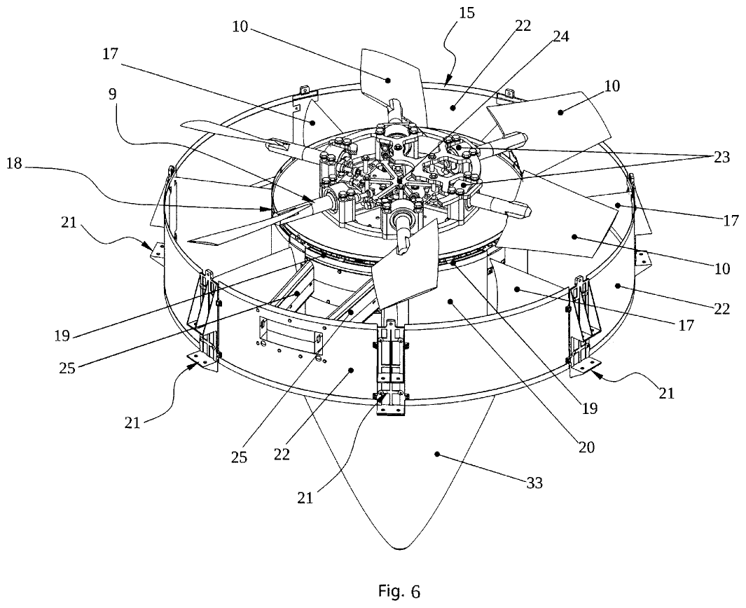

According to the exemplary embodiment shown, each of the at least four thrusters, the front thrusters 5 and the rear thrusters 6, includes:
an inlet air duct 26 having a narrowed portion in which at least one fan 9 is disposed. The inlet air duct 26 is formed by a fairing cover 27, made as one-piece or of separate elements, also forming part of the casing 3 around the respective fan 9 of the vertical take-off and landing aircraft 1;
at least one fan 9 with blades 10 having a variable angle of attack. The number of blades 10 is selected so as to obtain the highest ratio between the thrust generated and the power consumed by the fan 9. In the particular example embodiment shown in FIGS. 5 and 6, the number of blades 10 is six, but this does not limit the possibilities for selecting the number and size of blades 10. Preferably, the rotation of two adjacent fans 9 is in opposite directions as shown in FIG. 3 with arrows. Each fan 9 has a transmission shaft 11 (FIG. 5) connected by a flexible gear 12 of the belt or chain type, to a reduction gear 13, 14—a front reduction gear 13 and a rear reduction gear 14, respectively. The transmission shaft 11 of the fan 9 is hollow and is bearing in a straightening device 15 located below the fan 9. The torque transmission from the engine 4 to the fans 9 is entirely mechanical, with a pulley 16 of the flexible gear 12 mounted on the transmission shaft 11 of each fan 9, as illustrated in FIG. 5;
a straightening device 15 which is located below the fan 9 and rigidly mounted to the frame 2. In the present invention, the straightening device 15 comprises stationary radial blades 17 serving to straighten the air flow and mounted with their inner end to a hub 18 of the straightening device 15. In the embodiment shown, the hub 18 is a truss structure 19 enclosed by thin-walled panels 20 as best shown in FIG. 6. The stationary radial blades 17 have an outer end with mounting parts 21, to which outer end enclosing thin-walled panels 22 are fixed, and the straightening device 15 is mounted to the frame 2 by the mounting parts 21. A variable angle of attack control mechanism 23 for the blades 10 of the fan 9 is also mounted to the hub 18. This control mechanism 23, according to the exemplary embodiment, comprises a lever system with a guide axis 24 controlled by two stepper motors, and a sensor to measure the position of the blades and to send feedback data. In the particular example the guide axis 24 of the lever system is disposed in the hollow transmission shaft 11 of the fan 9, which is also bearing in the hub 18. Thus, the entire construction is compact. The control mechanism 23 of the variable angle of attack of the blades 10 of the fan 9 may itself be designed according to the requirements of each particular project according to various design schemes which are within the scope of the ordinary knowledge of one skilled in the art. Alternative designs of the hub 18 of the straightening device 15 may also be used, including it may be made as a casting, stamping of aluminium or other sheet metal, fabrication from composite materials, and the like. The illustrated example embodiment is preferred because of the good ratio between stiffness of the structure and weight, and because of the relatively simple manufacturing technology. Protecting covers 25 (FIG. 6) are also provided in order to enclose the flexible gear 12 (belt or chain) connected to the hollow transmission shaft 11 of the fan 9, which flexible gear 12 is partly located in the straightening device 15. The protecting covers 25 make it possible to avoid disturbing the air flow passing through the thrusters 5, 6;
an outlet air duct 28 formed by a lower fairing cover 29 (FIG. 2), made as one-piece or of separate elements, fitted to the outer enclosing thin-walled panels 22 of the straightening device 15 and to the frame 2, whereby a part of the casing 3 is also formed under the corresponding straightening device 15 of the vertical take-off vehicle 1. To at least two of the lower fairing covers 29 of the thrusters a horizontal axis 30 is bearing with guide flaps 31 connected to a mechanism (not shown) rotating them about the horizontal axis;
guide flaps 31 shown in FIGS. 2 and 4—these guide flaps 31 are located in the outlet air ducts 28 of the thrusters 5, 6 which are located diagonally relative to each other, for example, on the front left thruster and the rear right thruster or on the front right thruster and the rear left thruster. The guide flaps 31 partially change the direction of the outgoing airflow from the thruster to which they are mounted, creating a lateral force that rotates the aircraft about a vertical axis. It is possible to place the guide flaps 31 also on each of the thrusters 5, 6 to achieve a higher rotation speed about the vertical axis of the aircraft 1, passed mentally through its centre of mass, but in the example the embodiment with two guide flaps 31 is preferred because of their smaller total mass.
inlet fairing 32 and outlet support fairing 33—each front thruster 5 and rear thruster 6 has an inlet fairing 32 and outlet support fairing 33. Accordingly, the inlet fairing 32 is mounted on the fan 9 and is intended to direct the incoming air flow and prevent vortices from forming as air is drawn by the fan 9. The outlet support fairing 33 is mounted to the straightening device 15 with its fairing surface downwardly, and also has the function of a landing support for the aircraft 1. The purpose of the outlet support fairing 33 is to prevent the formation of vortices by the outlet air flow.

The fairing covers 27 of all inlet air ducts 26 are mounted to the outer enclosing thin-walled panels 22 of the straightening device 15 and to the frame 2.

The torque from the internal combustion engine 4 is transmitted towards the transfer case 8 via the clutch 34, which is suitably, for example, friction multi-disc (FIG. 4), but any suitable clutch for a particular design may be selected. The clutch 34 is intended to be electronically controlled and should always be disengaged when the engine 4 is started to break the connection between it and the fans 9. The cardan shafts—front cardan shaft 35 and rear cardan shaft 36 respectively—are, preferably lightweight, for example made of composite materials such as carbon fibre and with flanges of aluminium alloys having high mechanical properties, as seen in FIG. 4. The torque is transmitted by the front reduction gear 13 and by the rear reduction gear 14 to their respective fans 9 via the flexible gears 12. In the example illustrated in FIG. 5, a belt gear is shown, which is preferred as being lighter. The belts of this flexible gear 12 are selected to be with very high mechanical properties. The reduction gears, front 13 and rear 14, are designed to provide rotation of the adjacent fans 9 in opposite directions as shown in FIG. 3. Suitably, the reduction gears are constructed of as lightweight materials as possible with very high strength properties to maintain a minimum weight of the vertical take-off and landing aircraft 1.

In the embodiment of the invention contemplated herein, fuel energy is used for propulsion—for example, standard high-octane gasoline and/or synthetic gasoline—which energy is converted to mechanical energy by an internal combustion engine 4 suitably selected for each particular project, for example, a suitable type is a reciprocating high-frequency engine commonly used for racing cars, such as that shown in the attached figures. It is also possible that the vertical take-off and landing aircraft 1 may be powered by an engine 4 of another type, for example a rotor engine, a gas turbine engine or other.

In the present embodiment, the fuel supply system comprises a fuel line 37, FIG. 4, a fuel tank 38, a fuel pump 39 and fuel hoses from the fuel pump 39 to the internal combustion engine 4, which are constructed in the usual manner.

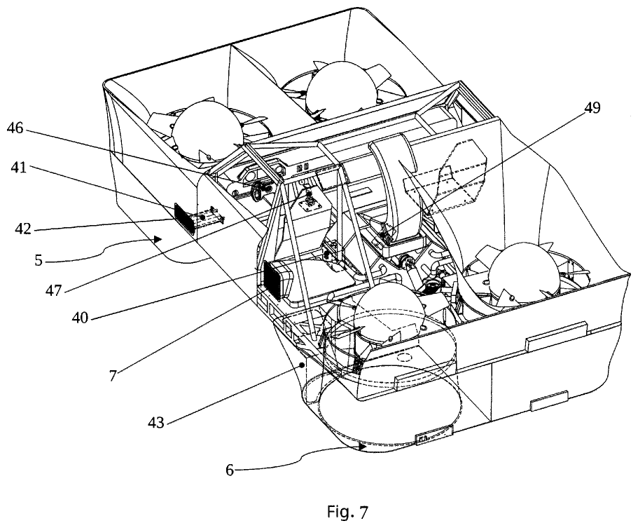

In the shown embodiment, a common lubrication system with a corresponding cooling system is provided for lubricating the transfer case 8 and the reduction gears 13, 14. In the particular example, the common lubrication system includes an oil reservoir 40 coupled to an oil pump 49 and an oil cooler 41 for cooling the oil shown in FIG. 7, executed as known in the art. Of course, for any particular project, the lubrication system schematic and specific embodiment will be created based on the knowledge of those skilled in the art in the application of conventional engineering design. This also applies to the specific design of the fuel delivery system.

Cooling systems are provided in the aircraft, for the oil of the reduction gear and the transfer case described in the preceding paragraph, and for the cooling of the internal combustion engine 4 comprising, according to the example presented, two radiators 48 with radiator boxes. The cooling systems have inlet grilles, a grille 7 for the cooling system of the internal combustion engine 4 and a grille 42 for the oil of the gears and the transfer case, which inlet grilles 7, 42 are formed in the casing 3 of the aircraft 1. The inlet grilles 7, 42 of the two cooling systems are connected to corresponding cooling ducts 43 formed between the respective inlet grilles 7, 42 and the outlet ducts 28 of the respective thrusters, either the front thruster 5 or the rear thruster 6.

In more detail, as shown in FIG. 2 of the present exemplary embodiment, the oil cooling system includes at least one oil cooler 41 surrounded by a set of baffles and panels forming an enclosed volume (box) around the oil cooler 41, which has two openings, an airflow inlet and outlet, and a cooling duct 43 to the outlet air ducts 28 of one of the front thrusters 5, in the example shown, a front left thruster—FIG. 2. The oil cooling radiator in this example is a single radiator, positioned on the pilot's side of the vertical take-off and landing aircraft 1. The airflow required to cool the lubricating system is formed on the basis of the jet principle of operation in hydraulic and pneumatic machines. The air jet created by the fan 9 and directed by the straightening device 15 passes through the outlet air duct 28 and entrains volumes of air located in the cooling duct 43 extending between the inlet grille 42 at the inlet of the oil cooler box 41 (FIG. 7) and the outlet air duct 28 of the corresponding thruster 5. Along the length of the cooling duct 43, the pressure decreases, being lowest at the outlet air duct 28 of the thruster 5, and is substantially equal to atmospheric pressure towards the inlet grille 42 of the radiator box inlet. As a result of the pressure difference, an air flow 44 is formed, shown by arrows in FIG. 2, which on its way passes through the oil cooler 41 and removes heat therefrom.

In the example shown, the cooling system of the internal combustion engine 4 is implemented by means of two radiators 48 mounted, one on each side-left and right, of the vertical take-off and landing aircraft 1, with their inlet grilles 7 shown in FIG. 2 and FIG. 7. It is intended that the organization of the air flow for the removal of heat therefrom to be as in the case of the oil cooler 41, the difference being that the engine cooling ducts 43 (FIG. 7) are located in the outlet air ducts 28 of the rear thrusters 6.

The power supply of the vertical take-off and landing aircraft 1 is implemented similarly to that of a passenger car. A rechargeable battery 45, which can be seen in FIG. 2, is placed in the front of the machine, and which is better lightweight, selected with the necessary parameters to ensure the starting of the internal combustion engine 4.

The rechargeable battery 45 in the exemplary embodiment of the vertical take-off and landing aircraft 1 shown is positioned at the front, farthest from the geometric centre of the aircraft, to compensate for the greater weight of the engine and other components located at the rear and to obtain a good longitudinal balancing of the aircraft. Of course, any other design that satisfies the balance conditions would be subject to engineering design based on the ordinary knowledge of one skilled in the art without going beyond the scope of the present invention. A generator (alternator) is mounted on the internal combustion engine to power electrical consumers on the aircraft and to charge the battery, which is not shown in the diagram. It is also appropriate to fit an additional, smaller generator on the engine to cover the needs of its ignition system and the electronic control unit in the event of an emergency. For the electrical mass of the rechargeable battery 45, the generator and all the electrical components, the frame 2 of the vertical take-off and landing aircraft 1 is used, which is preferably made of aluminium alloy without eliminating the possibility of making the frame of other materials such as composite, other metals and alloys, plastics, etc. In a compartment of the casing 3 provided for passengers are placed two boxes with relays and fuses as well as an additional box with fuses. The relays are used to control: the electric motor driving the clutch; the engine starter; the lights; the windscreen wipers, etc. The latter are also not shown on the diagrams due to their design being within the usual knowledge of a specialist in the field. Their mass, as well as that of other elements not shown, should be taken into account when calculating the dynamic performance of vertical take-off and landing aircraft 1. Similarly to most small aircrafts, switches are provided in the passengers compartment, to interrupt the electrical circuits of the rechargeable battery 45 and of the generator in the event of fire. A switch is also provided for controlling the clutch 34, which must be disengaged in order to start the internal combustion engine 4.

In a preferred embodiment, two devices, a steering wheel 46 and a joystick 47, are provided for controlling the vertical take-off and landing aircraft 1. This does not restrict any choice of control devices, steering wheel only or joystick only, or any other of the devices known and applied for this purpose, or any combination thereof.

### APPLICATION OF THE INVENTION

The application of the invention is realized by making the individual components and interconnecting them as described above. Further, use of the vertical take-off and landing aircraft 1 is carried out as follows:

When the vertical take-off and landing aircraft 1 is in stall, it is stepped on the outlet support fairings 33 at the bottom of the front 5 and rear 6 thrusters.

For the aircraft to take off, the internal combustion engine 4 is started with the clutch 34 disengaged. Once the clutch 34 is engaged, the torque from the engine 4 is transmitted via the transmission, in this case to the transfer case 8 and to the reduction gear, front 13 and rear 14, via the cardan shafts, front cardan shaft 35 and rear cardan shaft 36 respectively. These in turn transmit torque to the fans 9 via the flexible gears 12, either belt or chain. A top-down air jet is formed which allows the vertical take-off vehicle 1 to be lifted vertically from the place on which it is standing. In doing so, the rotation of any two adjacent fans 9 is in opposite directions, allowing stable take-off and flight parameters.

The flight control of the vertical take-off and landing aircraft 1 according to the invention is carried out by adjusting the angle of attack of the blades 10 of the fans 9 on one or more thrusters 5, 6. In the present example, since the connection between the engine 4 and the fans 9 is mechanical, all the fans 9 rotate at the same speed. Through the control mechanism 23 of the variable angle of attack of the blades 10 of the fans 9, the thrust generated by each individual thruster 5, 6 is varied. For example, to rotate the aircraft 1 about its longitudinal (roll) axis, the angle of attack of the blades 10 of the fans 9 of the left or right thrusters is decreased or increased, respectively the thrust generated by these thrusters 5, 6 is decreased or increased. With this change, a lateral force is also generated which moves the aircraft 1 in a lateral direction in a horizontal plane. The rotation about the lateral (pitch) axis is accomplished by changing the angle of attack of the fans 9 of the front thrusters 5 or of the rear thrusters 6. During this rotation, a force is generated which moves the aircraft 1 forward or backward in the horizontal plane. Thus, the forward movement of the aircraft 1 is also realized. The rotation about a vertical (yaw) axis is accomplished by means of the guide flaps 31, which in the exemplary embodiment shown are mounted on the front left and rear right thrusters. The guide flaps 31 are driven by a mechanism rotating them about their horizontal axis 30. When the guide flaps 31 are displaced from their neutral position, a portion of the air stream changes its direction and a lateral force occurs which creates a torque about a vertical axis thought to be drawn through the centre of mass of the aircraft 1.

For the sake of clarity regarding the operation of the thrusters 5, 6, here are the functions performed by their elements as follows:

The inlet air duct 26 of each thruster 5, 6 directs the incoming air flow entering the fan 9 and prevents the formation of vortices as air is drawn by the fan 9. Low-pressure zone is formed above. The low pressure acting on the inlet air duct 26 creates an additional lifting force. It is transmitted to the frame 2 through the connection points of this air duct 26 to the straightening device 15 and to the frame 2. The other main function of the inlet air duct 26 is as part of the casing 3 of the aircraft 1, serving as a covering for part of the frame 2 and the elements arranged thereon.

The outlet air duct 28 of each thruster 5, 6 has the following main functions: one of these is that, together with the outlet support fairing 33, it creates a space in which the airflow leaving the straightening device 15 of the thruster 5, 6 is calmed and shaped, helping to reduce vortices and thrust losses from the air stream. The second function is that it forms part of the casing 3 of the aircraft 1 and protects the elements beneath. Furthermore, it serves as a support for the guide flaps 31 serving to rotate the aircraft 1 about its vertical axis, as well as a place for air to be discharged by the cooling ducts 43 for cooling the internal combustion engine 4 and the oil cooler for the reduction gears 13, 14 and the transfer case 8.

In the illustrated embodiment, control of the aircraft 1 is performed by a pilot primarily using a steering wheel 46 with a rotation angle sensor mounted thereon and with a joystick 47 shown in FIG. 7. The steering wheel 46 controls the rotation about the vertical axis of the aircraft 1, and the joystick 47 controls the rotations about the longitudinal and lateral axes thereof. Buttons on the joystick 47 or the steering wheel 46 in the exemplary embodiment under consideration control the up and down movement of the aircraft 1. It is also possible to implement this translation with foot pedals, not contemplated in the present example, but possible for use in embodiments different therefrom. Of course, other control configurations than those described above are also possible. The signals from the joystick 47 and the steering wheel 46 may well be received by an electronic control unit for controlling the angles of attack of the blades 10 of the fans 9, which is in fact an electronic flight control unit, together with data from sensors for air temperature, atmospheric pressure, airspeed of the aircraft, engine crankshaft speed, and the like. The received signals are processed and transformed into control signals for the variable angle of attack control mechanisms of the blades 10 of the fans 9 and the displacement of the guide flaps 31 of the thrusters 5, 6. A control signal from this electronic unit is also sent to the electronic control unit of the internal combustion engine 4 for the required power.

The pilot receives feedback on the movement of the vertical take-off and landing aircraft 1 and status data from the instrument panel and from a corresponding information system. The instrument panel normally contains the following instruments: an internal combustion engine rev counter; a combination instrument (for example “six pack”, used in aircraft) for measuring altitude and airspeed, roll angles with respect to the longitudinal, lateral and vertical axes and vertical speed; a fuel level gauge; and an internal combustion engine temperature gauge. A range of machine data may be displayed on the information system, including power used by the internal combustion engine 4, by each of the fans 9, fuel pressure, oil temperature in the transfer case 8, etc. It may also be used for a navigation system, and to display ambient air temperature data, humidity data, etc.

Entry of the pilot and passenger into the vertical take-off and landing aircraft 1 is as for a conventional vehicle. Seat belts shall be provided at the time of manufacture. The space around the pilot and the passenger is enclosed and isolated from the engine and the fans by bulkheads and covers forming part of the casing 3. Landing is made on the outlet support fairings 33 at the bottom of the thrusters 5, 6.

1. (canceled)

2. An aircraft according to claim 14, characterized in that any two adjacent fans have opposite directions of rotation.

3. (canceled)

4. (canceled)

5. An aircraft according to claim 14, characterized in that the flexible gears are of the belt or chain type.

6. An aircraft according to claim 14, characterized in that each reduction gear is connected to a pair of fans.

7. An aircraft according to claim 14, characterized in that cooling systems are provided for the internal combustion engine and for the reduction gears and the transfer case.

8. An aircraft according to claim 7, characterized in that the cooling systems have radiator boxes with inlet grilles formed in the casing and connected to corresponding cooling ducts formed between the inlet grilles and the outlet air ducts of the respective thrusters.

9. An aircraft according to claim 14, characterized in that the straightening device has stationary radial blades mounted to a hub to which a control mechanism is also mounted for varying the angle of attack of the blades of the fan.

10. An aircraft according to claim 9, characterized in that the hub of the straightening device is a truss structure to which the stationary radial blades are mounted via their inner end.

11. An aircraft according to claim 10, characterized in that the hub is enclosed by thin-walled panels.

12. An aircraft according to claim 9, characterized in that the hub of the straightening device is made as a casting.

13. An aircraft according to claim 9, characterized in that the stationary radial blades of the straightening device have an outer end with mounting parts mounted to the frame to which outer end are fixed outer enclosing thin-walled panels.

14. A vertical take-off and landing aircraft comprising a frame with a casing and at least one internal combustion engine, which engine is mounted to the frame and is connected by a transmission to at least four fans with blades having a variable angle of attack and which at least four fans have a transmission shaft and which fans are parts of at least four thrusters, characterized in that each thruster includes an inlet air duct having a narrowed portion in which the fan is disposed, the inlet air duct is formed by a fairing cover, also forming part of the casing and the transmission shaft is bearing in a straightening device located below the fan and rigidly mounted to the frame, wherein an outlet air duct is provided below the straightening device, wherein an inlet fairing is mounted on each fan and an outlet support fairing is mounted to the straightening device, wherein guide flaps are mounted in at least two of the outlet air ducts and the transmission comprises a transfer case connected to the internal combustion engine via a clutch, which transfer case is connected via a front cardan shaft and a rear cardan shaft to a front reduction gear and a rear reduction gear which are connected via flexible gears to the fans.
